(19) United States
(12) Patent Application Publication
(10) Pub. No.: US 2004/0260588 A1
(43) Pub. Date: Dec. 23, 2004

(54) Method and system for business planning and improved business performance

(76) Inventor: Katherin Bowen, Portland, OR (US)

Correspondence Address: BRADLEY M GANZ, PC, P O BOX 10105, PORTLAND, OR, 97296

(21) Appl. No.: 10/875,427

(22) Filed: Jun. 23, 2004

Related U.S. Application Data
(60) Provisional application No. 60/482,062, filed on Jun. 23, 2003.

(51) Int. Cl. G06F 17/60

(52) U.S. Cl. 705/7

(57) ABSTRACT

The present invention works as a mechanism for aligning performance in project management with a plurality of objectives in operations, finance, and marketing. It is also a mechanism for defining parameters of quality-control measures by aligning with performance measures and objectives in operations.

The present invention provides a service management by defining parameters in serving employees or external relationships, including customers, suppliers, vendors, subcontractors, and consultants. These measures may be applied to objectives in operations and marketing. The invention also assists in identifying and developing long-term and beneficial relationships for long-term business. Generally, these relationships are found in the company's marketplace. Whether internal (employees) or external (subcontractors, subconsultants, suppliers, or vendors), teamwork or team building is inherent in the design and construction industry and specifically demonstrated in project performance. The expected results and benefits from teamwork are understood when project roles and responsibilities are aligned with company's objectives. Long-term relationships are revenue sources for referral work and contribute to a company's efficiency in achieving objectives. These relationships reduce cost and risk of “grass roots development” in a probable merger or acquisition. In setting objectives, long-term relationships can leverage into stronger market position.

The present invention teaches a company to positively capture and direct creativity in adjusting performance for innovation and continuous improvement.

### RELATED APPLICATIONS

This application claims priority from U.S. Provisional Application Ser. No. 60/482,062, filed Jun. 23, 2003, the contents of which are hereby incorporated by reference as if recited in full herein for all purposes.

### BACKGROUND OF THE INVENTION

The present invention generally relates to a method and system for business planning and improved business performance. It is particularly suited for use in construction-related fields. Accordingly, to illustrate the principles in the present invention, it will be described in terms of design professionals and contractors.

Many design professionals and construction contractors who operate independent businesses lack formal education or training in running a business. The success or failure of the operator's business depends on much more than their reputation or technical skill. Many operators find it challenging to improve their businesses using traditional consulting models. For example, traditional business planning and performance may be improved using what is known as a “strategic plan.” The strategic plan helps provide focus on where a company is going and how it will get there.

In developing strategic business plans for design and construction companies, operators need practical orientation from project experience before setting a vision for the company to express its core values and purpose. The emphasis on projects gives the company motive and opportunity to continually improve its capacity for future performance and to move toward its vision. This method is analogous to constructing the foundation of a structure before placing the roof. However, traditional strategic plans often fail from poor implementation because business operators may not be amenable to traditional business management or learning. The design and construction industry is particularly challenged with implementing plans because this industry inherently performs site-specific projects with a decentralized workforce.

Accordingly, there is a need for business planning and performance improvement methods and systems that may be easily and readily implemented in the construction industry and other industries.

### SUMMARY OF THE INVENTION

The present invention is a method and system for structuring a design company, construction company, or other business into a learning organization-that is, into an organization that analyzes its past and current projects (hereinafter called “actual” projects) and that promotes on-the-job workforce training. The present invention represents an empirical, ground-up approach based on actual projects viewed through the business functions of operations, finance, and marketing to yield objectives, benchmarks, job descriptions, and worker-performance metrics which together contribute to ongoing improvement in business practice. It is therefore well suited to the practical personalities often attracted to design and construction businesses.

Design and construction business are inherently project-oriented. A residential remodeling contractor, for instance, probably has a history of renovation projects culminating in projects currently in progress. To apply the principles of the present invention, the business operator starts by identifying a set of actual projects for use in evaluating a set of business functions selected from the group comprising operations, finance, and marketing (OFM). At the project level, operations comprises parameters that show the company's performance and use of resources during a particular project; finance comprises parameters relating to cost, price, and profit as to that project; and marketing comprises parameters that attracted that customer and attained that job. The operator analyzes each project by developing queries that yield project experience—that is, information and outcomes as to the project business functions. This process, iterated over the selected projects, is called “project OFM.”

After conducting project OFM, the next step is assembling the project experience gleaned from the project evaluations and propagating the result back into the company. During this phase, called “company OFM,” the operator assembles project data and outcomes to evaluate company-level business functions similarly selected from the group comprising operations, finance, and marketing. At the company level, operations comprises parameters and policies by which the company estimates projects, manages resources, and so on; finance comprises parameters and policies by which the company prices work, budgets expenses, manages capital, and so on; and marketing comprises parameters and policies for attracting business, promoting customer relations, and so on.

The next phase is developing a constructive business plan. This process comprises identifying sources of revenue, determining financial condition and working capital, specifying current OFM business functions, identifying issues in OFM business functions, and setting company OFM objectives. These objectives in turn reflect the company's core values, address any business issues to be overcome, and are selected to lend themselves to measurement and monitoring. In the context of OFM objectives, an example of an operations objective is improving performance by increasing the efficiency rate to improve the gross profit margin; an example of a finance objective is establishing a budget for general and administrative expenses; and an example of a marketing objective is targeting sources of revenue and measure by percentage of revenue earned.

After setting OFM objectives, the next step to establishing benchmarks and performance measures for monitoring the OFM objectives. Benchmarks often derive from outside sources such as industry standards; and performance measures often derive from the company's past performance and its desire for continuous improvement.

The business operator can now advance to identifying roles and responsibilities and assigning them to persons or businesses selected from the group comprising employees, subcontractors, and vendors, collectively called workers. Substeps here comprise developing job descriptions for workers and developing “expected results” as a technique for measuring worker performance as it contributes to company performance. These worker-performance metrics, based on company OFM objectives, are often developed as a collaboration between the company and worker.

The business operator may repeat one or more of the above steps based on monitoring of performance for the business functions relative to future projects as they become actual projects.

A plan according to the principles of the present invention thus guides business operators through managing industry issues, including use of resources and transferable skills from other industries while aligning industry-related educational programs or resources like community colleges, vocational-technical programs, or apprenticeship programs. Further, the invention works as a mechanism for aligning performance in project management with objectives in operations, finance, and marketing. It is also a mechanism for defining parameters of quality-control measures by aligning with performance measures and objectives in operations.

The present invention provides a service management by defining parameters in serving internal relationships (employees, for example) or external relationships (customers, suppliers, vendors, subcontractors, and consultants, for example). These measures may be applied to objectives in operations and marketing.

The present invention assists in identifying and developing long-term, beneficial business relationships. Generally, these relationships are found in the company's marketplace. Whether the relationships are internal or external, teamwork or team building is inherent in the design and construction industry and is specifically demonstrated in project performance. The expected results and benefits from teamwork are understood when project roles and responsibilities are aligned with company's objectives. Long-term relationships are revenue sources for referral work and contribute to a company's efficiency in achieving objectives. These relationships reduce cost and risk of “grass roots development” in a probable merger or acquisition. In setting objectives, long-term relationships can leverage into stronger market position.

The present invention teaches a company to positively capture and direct creativity in adjusting performance for innovation and continuous improvement.

The foregoing is not intended to be an exhaustive list of embodiments and features of the present invention. Persons skilled in the art are capable of appreciating other embodiments and features from the following detailed description in conjunction with the drawings.

### BRIEF DESCRIPTION OF THE DRAWINGS

FIG. 1 shows an overview of a company and its business situation or “siting” with respect to a community, marketplace, and planning activities.

FIG. 2 shows a company, its projects, its business functions, and the process of formulating a constructive business plan according to the principles of the invention.

FIGS. 3A and 3B together show a flow diagram of steps for a method in accordance with the principles of the present invention. FIG. 3B is a continuation of FIG. 3A, and the last step in FIG. 3A connects to the first step in FIG. 3B.

FIG. 4 shows a diagram of an application of a plan for workforce development in accordance with the principles of the present invention.

FIG. 5 shows a diagram of a representative embodiment of the present invention wherein remote computers interact with a database using a network, such as the Internet.

### DETAILED DESCRIPTION OF THE INVENTION

The present invention is a method and system for structuring a design company, construction company, or other business into a learning organization, so that it captures project experience and transferable workforce skills. The present invention uses project performance as a strength in gaining results. The operator applies the mechanism for monitoring and reinforcing or adjusting the company's progress in achieving one or more objectives through project activities and makes informed business decisions at all levels.

The present invention combines linear and sequential analysis in an outcome-based process. The business method is linear in identifying project experience with a business function (operations, finance, or marketing), and analyzing the experience into setting one or more company objectives for that function. The method is sequential to the extent that one function has a one-way dependency on another function. Thus, the method begins with analysis of projects to set objectives in company operations; it then resumes project analysis to set objectives in company finance; and it then applies same process to set objectives in company marketing.

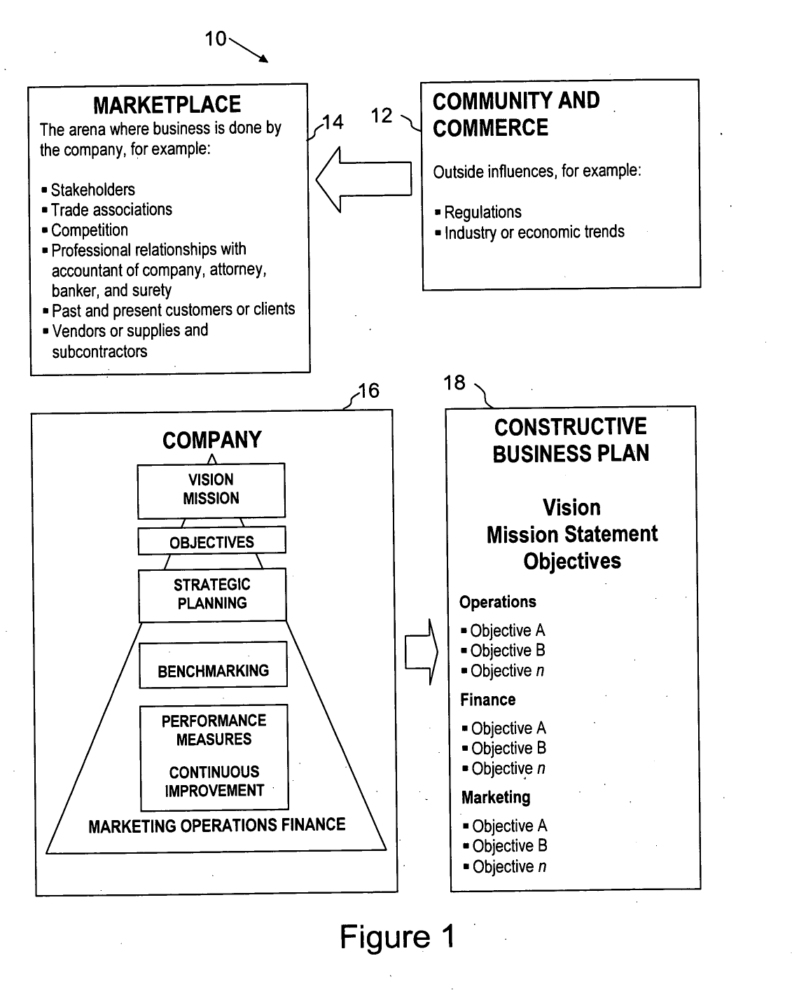

Referring to FIG. 1, which illustrates principles in accordance with the present invention for orientating the company to its “siting” or situation that determines its status quo for transacting business, a company 16 is part of a business context 10 also comprising a community 12 and a marketplace 14. Community 12 comprises the outside influences generally affecting commerce such as regulations and trends. Marketplace 14 is a business arena relevant to company 16 and therefore comprises stakeholders, trade associations, professional relationships, customers, vendors, and the like.

Company 16, operating within marketplace 12 and community 10, has goals and methods expressible as its vision, mission, and objectives. A company's vision is its view of its optimal future and conveys its ethics, core values, and purpose for inspiration and direction. A company's mission is a brief formulation of its purpose with reference to its customers, products, services, markets, philosophy, and technology. The mission therefore represents timely goals and shows how the company will travel towards its vision. A company's objectives connect its functions in operations, finance, marketing, and other business functions with its mission and vision.

Company 16, by applying the methods and systems according to the present invention, develops a constructive business plan 18 that is based on its actual project experience and that expresses its vision, mission, and general objectives in the context of its specific operational, financial, and marketing objectives.

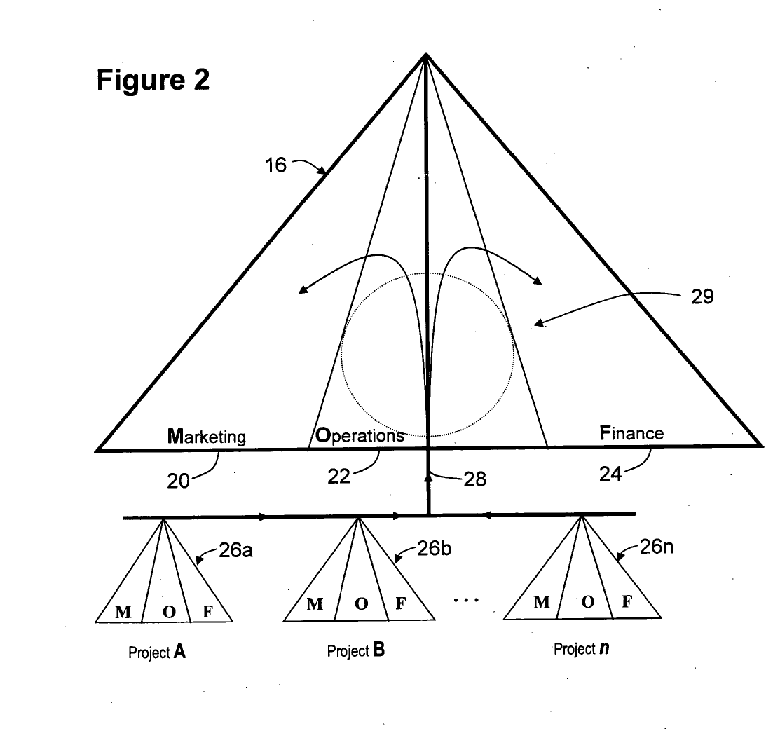

FIG. 2 details a representative company 16, symbolized by a triangle to show the ground-up principles of the present invention and to convey a reversal of the traditional top-down process of strategic planning.

Company 16 comprises business functions 20, 22, and 24 and engages in a plurality of actual projects 26a through 26n. Company marketing 20 includes the collection and interpretation of information about current and past projects, types of clients and customers, the ability to obtain work, and other similar business data. Company operations 22 includes the infrastructure required to accomplish tasks and goals such as but not limited to the use of company resources and the scope of work and services. Company finance 24 includes the company's economic infrastructure and comprises pricing and payment arrangements, overhead assigned to projects, cash flow from projects, and profit.

Company 16 has a plurality of projects 26a through 26n representing services performed for clients, products sold to clients, or both. Each project has its own business functions comprising operations, finance, and marketing. When practicing the method taught by the present invention, company 16 identifies a set of projects for analysis and develops queries to evaluate business functions for each project 26a through 26n. Company 16 then assembles the project-level OFM information and propagates this project experience 28 from actual projects 26a through 26n “upward” into company 16. Project experience 28 drives the constructive planning process 29 whereby company 16 sets objectives for business functions 20, 22, 24 and goes on to perform subsequent planning steps such as setting benchmarks, assigning roles, and so on.

Summarizing, the present method starts by analyzing projects at the base of the triangle and then moves upward into setting company objectives in operations, finance, and marketing, among other functions. The objectives are directed and focus toward the company's mission and vision.

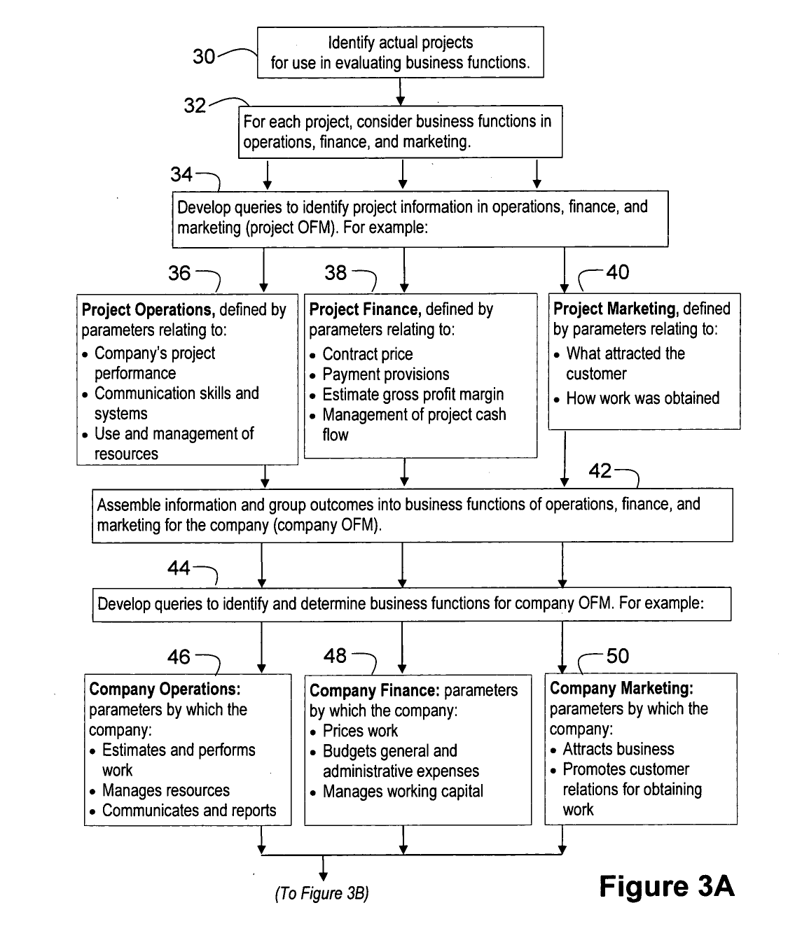

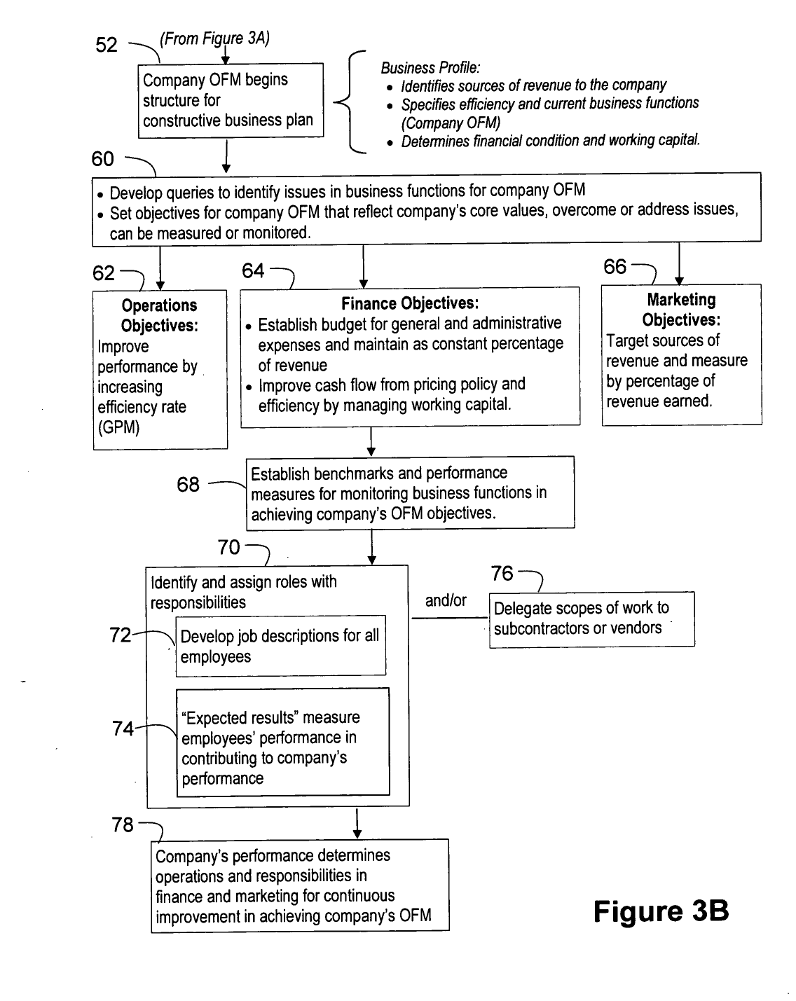

Referring to FIG. 3, the first step in applying the business method taught by the present invention is identifying actual projects 30 for use in evaluating business functions selected from the group comprising operations, finance, and marketing (OFM). This project-level OFM evaluation assists the operator in identifying project experience 28 from the selected actual projects 30 by considering the project-level OFM functions 32 and developing queries 34 as to those functions. Project operations 36 comprises parameters that show the company's performance, communication, and use of resources during a particular project; project finance 38 comprises parameters relating to cost, contract price, cash flow, payment provisions, and gross profit margin, among other things, as to that project; and project marketing 40 comprises parameters that attracted that customer and attained that job. This evaluation, iterated over the selected projects, is called “project OFM.” Proceeds from this analysis go to determining from the project evaluations a set of business issues that influence each business function for actual projects.

For instance, the operator of company 16 thinks about the design or construction of a project for its specified purpose on a selected site (project operations 36); job costs and profit (project finance 38); and meeting the customer's expectations (project marketing 40). This analysis of each project renews understanding that design and construction of each project is unique, and that each embodies the OFM business functions.

During project OFM, the operator gathers initial project information into OFM business functions. First, the operator analyzes project operations 36 by defining parameters that show project performance, communication, and use and management of resources, for example. This analysis includes developing project queries 34 about, for example, scope of work or services, communication, gross profit margin, contract scope-of-work or services, and use or management of resources. In further analysis, the operator may group projects by types or activities, ranges in contract price, or private and public works or improvements, among other categories. Project queries 34 may, for example, evaluate management and organizational performance, measure efficiency, or internally assess project strengths and weaknesses. This analysis defines operations by project parameters on performance, use or management of resources, and communication or reporting.

After conducting project OFM, the next step is assembling the project OFM information 42 to propagate this project experience “upward” into company 16 as shown in FIG. 2. During this phase, called “company OFM,” the operator uses the project OFM results for developing company OFM queries 44 (similar to the project OFM queries 34) that identify and determine company-level business functions similarly selected from the group comprising operations, finance, and marketing. Company operations 46 comprises parameters and policies by which the company estimates projects, manages resources, and so on; company finance 48 comprises parameters and policies by which the company prices work, budgets expenses, manages capital, and so on; and company marketing 50 comprises parameters and policies for attracting business, promoting customer relations, and so on.

For example, the operator uses project parameters in project operations 36 for determining parameters of company operations 46. The operator begins the linear process by specifying the company's current performance and business structure or organization.

After conducting company OFM, the next step is beginning the structure for a constructive business plan 52—a process that depends in part on the company's business profile, which identifies sources of revenue, determines financial condition and working capital, and specifies efficiency and current business functions, among other things. The initial planning process includes developing queries 60 to identify issues in company OFM business functions. Addressing issues to be overcome requires setting objectives 62, 64, 66 that reflect the company's core values. In the context of company objectives, an example of an operations objective 62 is improving performance by increasing the efficiency rate to improve the gross profit margin; an example of a finance objective 64 is to establishing a budget for general and administrative expenses; and an example of a marketing objective 66 is to target sources of revenue and measure by percentage of revenue earned. Objectives, then, practically improve the company's performance by overcoming issues identified through previous queries.

In setting objectives, external opportunities or threats as well as benchmarks 68 from industry standards or competitors are considered. Then, the operator assigns performance measures 68 for achieving the objectives in operations. Sources for performance measures include the company's past performance and desire for continuous improvement.

Generally, queries used in situational analysis and defining project parameters may be applied as performance measurements to indicate the company's progress in addressing and overcoming issues. The operator can apply measures weekly, monthly, or quarterly in an ongoing evaluation of progress.

The operator can now advance to identifying roles and responsibilities 70 as action items and assigning them to persons or businesses selected from the group comprising employees, subcontractors, and vendors, collectively called workers. Substeps here comprise developing job descriptions for workers 72 and developing expected results 74 as techniques for measuring worker performance as it contributes to company performance. These worker-performance metrics, based on company OFM objectives, are assigned as expected results 74 in performing responsibilities and are often developed as a collaboration between the company and worker. Delegating scopes of work to subcontractors or vendors 76 is part of this process.

The Gross Profit Margin (GPM) may be used as a performance measure in operations. The company figures its GPM from its income statement as its efficiency rate in performance. As the company streamlines and improves performance, the GPM or rate of efficiency will raise. Thus, the GPM is regularly applied in monitoring and measuring the company's performance for achieving objectives in operations.

Sequentially, the operator uses project business functions 36, 38, 36 and evaluates parameters from operations to finance for identifying issues that cause a project to make or lose money. The operator gathers this project information into company finance 48. Then, the operator queries current or past projects in defining finance by parameters that determine pricing, contract payment provisions, equipment costs, or cash flow. In further analysis, the operator may see cash-flow trends within project groups. Queries 34 include, for example, rental, lease or purchase of equipment, pricing of overhead and profit, down payments or payment schedule, project strengths and weaknesses, and other finance or cash-flow issues from progress of work or job costs. In addition, the operator considers the project's influence on the company's cash flow and financial position.

In defining parameters of company finance 48, the operator internally assesses strengths and weaknesses in cash flow and finance by contract payment provisions, working capital, budget for overhead (general and administrative expenses), cash sources, and capital management planning. The assessment also determines the company's financial position for addressing or managing opportunities or threats.

In typically a linear process, the operator continues the structure for the method by specifying cash flow and financial position in the constructive business plan 52. Objectives are set in finance 64 to overcome issues, favorably manage the company's flow of cash, and improve financial position. Objectives may include increasing working capital or improving cash sources, finance management of capital or fixed assets and operators' equity. In setting objectives in finance, benchmarks 68 are applied from standards in bonding and insurance, construction lenders, or Construction Finance Management Association (CFMA). Then, the company assigns performance measures 68 for monitoring progress in achieving finance objectives 64.

The sequential interdependence of operations to finance allows the company's break-even amount to be favorably affected by the company's more-efficient performance in operations through objectives 62. The resulting financial benefit (profitability) can be allocated in a Finance Management Plan expressed as finance objectives 64. In managing this profitability from efficient operations, the operator can establish an overhead budget (general and administrative expenses) as a percentage of the amount of revenue generated. For example, the operator establishes and manages an overhead budget at 10% of revenue. When revenue increases, the amount of the overhead budget increases to 10% of revenue. Thus, when the company is efficient (GPM) in operations, the percentage of overhead-to-revenue becomes a performance measure for monitoring the company's profitability in finance through benchmarks and performance measures 68.

Another objective in finance may be to increase working capital and retire debt. From improved efficiency in operations, the Finance Management Plan (finance objectives 64) allocates cash flow for increasing the company's working capital and improving its debt-to-equity position. A performance measurement for improved cash flow may be a percentage increase in working capital from the previous accounting period, or an improved debt-to-equity ratio from appropriate payments in retiring debt.

In final sequence, the operator uses business functions within each project and defines parameters from operations and marketing for attracting customers, and identifying issues in obtaining work and promoting project performance. The operator gathers this project information into company marketing 46. Then, the operator queries current or past projects in defining marketing by parameters that analyze contractual relationships with customers, types of profitable projects or activities, geographic location, referrals through trade or professional associations, and the company's relationship with customers for probability of repeat or referral work.

In sequential interdependence from operations to finance to marketing, the operator identifies and defines sources of revenue for efficient work, an expression of company finance 44. The operator observes, among other things, patterns in how projects are obtained, how project performance promotes the company, and internal strengths and weaknesses for developing relationships in targeted sources of revenue. In project performance, relationships that contribute to profitable work are identified for long-term business with customers, vendors, suppliers, and subcontractors. These parameters may be used to define company marketing for promoting project performance to targeted sources of revenue.

The operator adds marketing information on sources of revenue to the structure for the constructive business plan 52.

Objectives in company marketing 66 are set to overcome marketing issues, improve the company's market appeal and ability to obtain work, develop favorable customer and long-term business relationships, and improve competitive marketing position. These objectives include determining and targeting sources of revenue for obtaining work that can be performed efficiently. Benchmarks 68 for company marketing may include percentage of market share from real-estate activity, housing starts, or permits issued. Performance measures 68 are assigned from company's historical records on repeat or referral work, volume of work from targeted revenue sources, or referrals from trade associations. For example, the company sets a marketing objective to increase revenue from its source of repeat customers. The company can track this source of revenue and the percentage of revenue from repeat customers can be used as a performance measure of customer satisfaction.

Finally, in setting company objectives in marketing from project parameters, the operator understands the strategies and tactics for attracting and obtaining work from targeted sources of revenue. Also, these objectives will attract projects needed for the company's experience and worker training in planning capacity for future performance. Further, the company's ability to get work is sequentially interdependent to its capacity to actual performance in operations; and cash flow and financial condition in finance. With this information, the company can target and pursue projects or activities that it can profitably and efficiently perform.

In focusing and directing objectives toward the company's mission, the operator knows how the company can overcome issues in a timely goal and achieve its vision. Thus, the operator analyzes the company's situation in the marketplace (FIG. 1) and specifies its improved position for transacting business and complying with regulations.

An outcome of the constructive business plan is to improve a company for financial stability and growth. The finance function serves the company in this business management responsibility. Consequently, performance measures are aligned with numerical or financial significance.

In addition to operations, finance, and marketing, there are intangible business functions like communication and management's ability to resolve problems, issues, or obstacles. These intangible functions are reflected in efficiency or turnover rates. The type of projects performed and the amount of company's capitalization will determine infrastructure and process for intangible business functions.

In analyzing the effectiveness of performance measures, the constructive business plan applies industry standard measures of small design and construction companies. A resource for this information is Financial Studies of the Small Business by Financial Research Associates, 510 Avenue J SE, Winter Haven, Fl. 33880. For purposes of the Financial Studies, small businesses are defined as having capitalization under $1,000,000. The Financial Studies compiles financial statement data on small business and provides guidelines for comparing financial ratios with companies of similar size. The comparisons encourage use of the median since it is not affected by extremes and the financial information is objective. The following example, drawn from Financial Studies of the Small Business 23^{rd} Edition, page iv, compares management of long-term debt in a sample size of 25 firms:

Total Current Liabilities Total Long Term Debt Total Liabilities

| | | Total Long | Total |
|---|---|---|---|
| | Total Current Liabilities | Term Debt as a | Liabilities as a |
| | as a % of Total Assets | % of Total Assets | % of Total Assets |
| Firm 1 | 24% | 00 | 24% |
| Firm 2 | 00 | 60% | 60% |
| Firm 3 | 00 | 00 | 00 |
| Mean | 8% + | 20% = | 28% |

The data is presented with asset-size breakdowns within each category. The breakdowns are for companies meeting criteria of total capitalization: $10,000 to $100,000; $100,000 to $250,000; $250,000 to $500,000; and $500,000 to $1,000,000. Individual analysis by overall category and asset size within each category includes sixteen ratios organized by liquidity, leverage, activity, and profitability. This detail allows the constructive business plan to determine industry benchmarks appropriate to a company's performance and size and apply performance measures.

Performance measures from this resource for small design and construction companies, or resources providing similar information for companies with capitalization over $1,000,000, provide benchmarks for a company in continuous improvement.

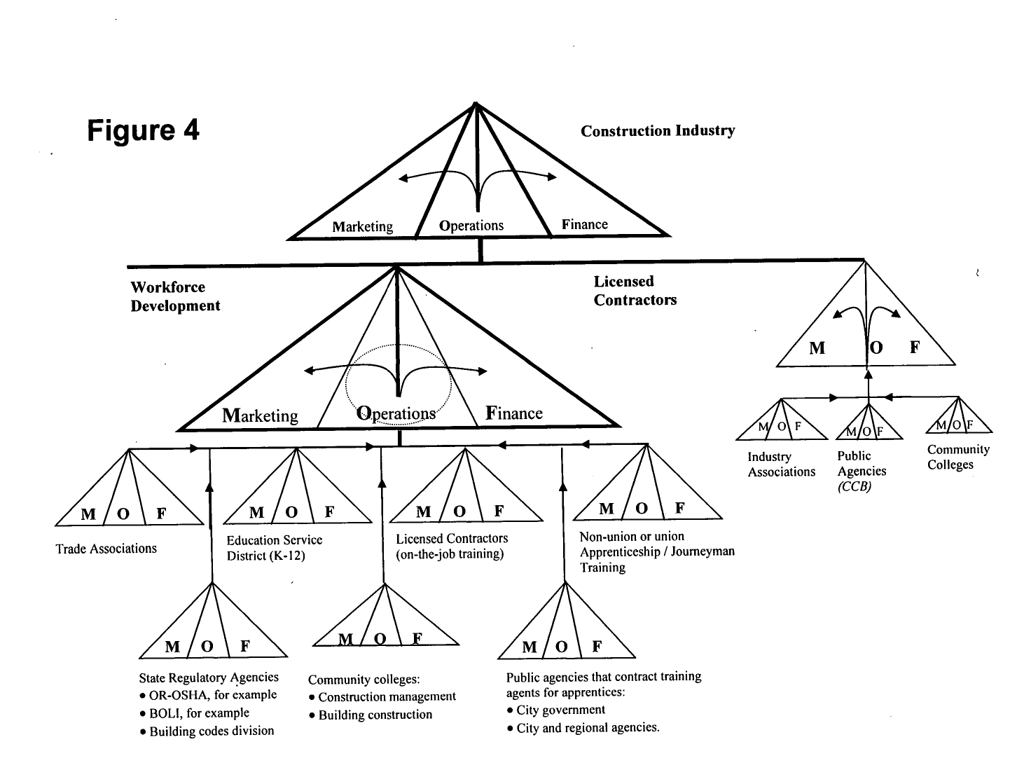

Referring to FIG. 4, in addition to applying a constructive business plan to a variety of business settings, the present invention also offers a mechanism for addressing or resolving design and construction industry issues such as workforce development. On-the-job training is the primary means for developing workforce in the design and construction industry. The business operator understands the skills and abilities needed in the company's workers and employees when roles and responsibilities are assigned in alignment with objectives. In seeing the company as a learning organization that contributes to workforce development through on-the-job training, operators seek industry relationships that serve the company's training needs.

FIG. 4 shows a plan for workforce development as an application of a constructive business plan; that is, FIG. 4 shows a mechanism for organizations to provide workers, which are sought by a company, and serve company's training needs. In FIG. 4, as in FIG. 2, a constructive business plan is symbolized by a triangle because the process assembles industry information into business functions at the base and integrates these functions in achieving the industry's vision at the summit.

The construction industry includes organizations, such as institutions or agencies, which provide professional services, training or education, and regulations for common good or benefit. In addressing industry issues within a geographic area, organizations will have collective and individual interest with programs that concern or influence those issues. Generally, the plan becomes the mechanism by which these organizations communicate purpose for establishing inter-industry relations and coordinate program resources for addressing or resolving issues.

In applying the plan, the mechanism starts with each organization examining the influence that an issue has on its program. An organization's program will generally consist of activities to perform (operations), find (finance), and promote (marketing). The influence can be measured by the program's objectives in operations, finance, and marketing. With this information, the organization adjusts performance in addressing the issue by aligning the program to achieve objectives. In meeting objectives for performance or operations, the program will achieve objectives in finance and marketing by generating financial resources and in becoming marketable for promotion.

By aligning the program to achieve the organization's objectives, the organization is clear about its efforts in addressing or resolving the issue. Within an industry, organizations will have individual purpose reflected in the program objectives. As organizations communicate about an industry issue, they are coordinating resources and sharing information developed and drawn for their programs. By collaborating on the measured influences of the issue on organizations' programs, the organizations begin to define the influence they have in addressing or resolving the issue for the industry. Through this inter-industry collaboration, organizations set objectives for long-term relationships that leverage resources in addressing or resolving the issue. The mechanism teaches the industry to positively capture and direct creativity by adjusting programs for addressing issues.

In applying the mechanism to workforce development, organizations offer programs and training to develop workers for employment in the industry. By examining the objectives with program performance, finance and marketing, organizations define their effectiveness in developing the workforce. Industry objectives that are not being met will be identified. For instance, a community college will offer different programs than would a vocational-technical school or an apprenticeship program. Yet all are striving to deliver skilled workers to the industry. Are they competing for the same students and appealing to none? Through collaboration, each organization will discern the type of construction company it serves.

In FIG. 4, vision conveys to stakeholders the industry's direction and purpose in developing workforce; mission focuses sectors'objectives for education and training into timely goal for achieving industry's vision in developing workforce; and objectives are sectors'goals that connect functions in operations, finance, and marketing with mission and vision. Here, examples of operations queries include queries that assess current resources, current employee or apprenticeship/journeyman education and training programs, use of educational resources and training programs, or leverage existing resources and training programs. Examples of financial queries include those relating to budgets and funding as well as to case sources, fundraising, and capital management plans. Examples of marketing queries include those directed at current recruitment and communication flow and reporting within industry in promoting education and training opportunities.

### Preferred Performance Measures

Preferred performance measures comprise gross profit margin, break-even, rate of overhead to revenue, working capital, bonding capacity, profitability, current ratio, and debt-to-equity ratio, among others, detailed below.

Gross Profit Margin (GPM) is the rate of efficiency. The formula for project performance measure (from the WIP report, described below) is as follows:

GROSS PROFIT=REVENUE EARNED−JOB COSTS

GROSS PROFIT MARGIN=GROSS PROFIT÷REVENUE EARNED

The formula for company performance measure, from income statement, is a follows:

GROSS PROFIT=REVENUE−GROSS PROFIT MARGIN

GROSS PROFIT MARGIN=GROSS PROFIT÷REVENUE

As the GPM raises, the company becomes more efficient in its operations. The rate may be applied as a company parameter in estimating and performing work on projects; or, as a performance measure for project managers in achieving an efficiency rate on a project-by-project basis.

Break even is the amount of revenue generated by the business to cover overhead when the company performs at a rate of efficiency. The company becomes profitable after its revenue exceeds the break-even amount. The formula for break-even amount, from income statement, is as follows:

$$BREAK EVEN = \frac{\begin{matrix}OVERHEAD ( OR GENERAL AND \\ ADMINISTRATIVE EXPENSES )\end{matrix}}{GROSS PROFIT MARGIN}$$

Overhead, also called General and Administrative Expenses, is a factor in a metric called Rate of Overhead-to-Revenue, which monitors the amount of overhead proportionate to revenue. When revenue increases or decreases, the company can adjust its budget for overhead in maintaining the same percentage and proportionate relationship of overhead-to-revenue. Also, this percentage is used in pricing for profitable work. The formula (from income statement) is as follows:

RATE OF OVERHEAD=OVERHEAD÷REVENUE

Working Capital is the money that is left over after subtracting current liabilities from current assets. Bankers and lenders look at working capital to determine a company's ability in managing its financial position as a result of the ongoing activities of the company. Generally, a minimum amount of working capital covers receivables, inventory and payroll. In other words, if the operator suddenly paid off all the debts by liquidating currents assets, working capital is the protective cushion to carry the company's receivables, inventory and payroll. Another consideration is maintaining an adequate amount of working capital in relationship to revenue so funds are available until revenue or payment is received for project performance. The formula, from the balance sheet, is as follows:

WORKING CAPITAL=CURRENT ASSETS−CURRENT LIABILITIES

Bonding Capacity is generally determined by bonding agent after looking at the amount of a company's working capital and its debt-to-equity ratio. Since the bond guarantees performance of a construction contract, the bonding agent needs to see that the company has an adequate amount of working capital for covering any claims brought against the company's bond. Generally, bonding capacity is figured from the balance sheet as follows:

BONDING CAPACITY=WORKING CAPITAL X10

Profitability in the plan is the probable amount of revenue generated in excess of the break-even amount.

Pricing formula for Contract Price is as follows:

ESTIMATED JOB COSTS/1-(PERCENT OR RATE OF OVERHEAD+PERCENT FOR PROFIT)

Current Ratio is a ratio that evaluates the company's financial strength and indicates the ability to convert assets into cash. When the current ratio shows a higher number for assets than liabilities (3:1), the company has more access to cash because assets are more than liabilities (company's financial obligations). The formula, from the balance sheet, is as follows:

CURRENT RATIO=CURRENT ASSETS÷CURRENT LIABILITIES

Debt-to-Equity Ratio is a ratio that compares the amount of debt (total liabilities) owed by the company with the amount of money in operators' equity. A financially secure company has a lower ratio (2:1) or the company's debt is twice the amount of equity. Also, the debt-to-equity ratio measures a company's leverage or ability to take risk. The greater the debt-to-equity ratio (5:1), the greater the company's ability for risk. The formula, from the balance sheet, is as follows:

DEBT-TO-EQUITY=TOTAL LIABILITIES÷OPERATORS' EQUITY

### Business Reports The following reports are preferred in queries and determining project parameters.

The Work-in-Progress Report (WIP Report) summarizes project information for a period of time consistent with the company financial statements (such as the income statement and balance sheet) and shows contract price, revenue earned, cost of goods sold and gross profit.

The WIP Report for a reporting period shows revenue earned that correlates to revenue or sales on an income statement for the same period. From the income statement, net profit (or loss) is reported on the Balance Sheet under Operators' Equity/Retained Earnings for the same reporting period.

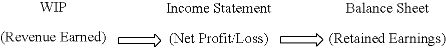

Financial Statements which include Income Statement and Balance Sheet Features of the plan according to the present invention: How project performance improves business position.

The plan gives the operator a mechanism for vertical thinking, consensus and teambuilding within the company; monitoring and measuring the company's progress in achieving objectives; making informed business decisions at all levels; reinforcing or adjusting the company's day-to-day activities; leading the company to an improved business position; understanding changes that occur in the marketplace and adjustments for continuous improvement; and redefining the company's position in the marketplace, such as, the feasibility of diversifying or pursing a new service or market; among other things.

The plan encourages the company to become a learning organization with continuous capacity to develop an internal environment conducive to efficiency and excellence that responds to the needs of its marketplace. The plan also encourages the company to continually expand its capacity for future performance.

The present invention may be embodied as methods and apparatus for practicing those methods. The present invention can also be embodied in the form of computer program code embodied in tangible media, such as floppy disks, CD-ROMs, hard drives, or any other computer-readable storage medium, wherein, when the computer program code is loaded into and executed by a computer, the computer becomes an apparatus for practicing the invention. As is well known in the art, the code for implementing features of the present invention can be implemented over a distributed computing system of clients and servers.

The program code encoded in tangible media creates the means for causing the computer to perform the various operations of the present invention. The present invention can also be embodied in the form of computer program code, whether stored in a storage medium loaded into and/or executed by a computer, or transmitted over a transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose computer, the computer program code combines with the computer to provide a unique device that operates analogously to specifically designed circuits.

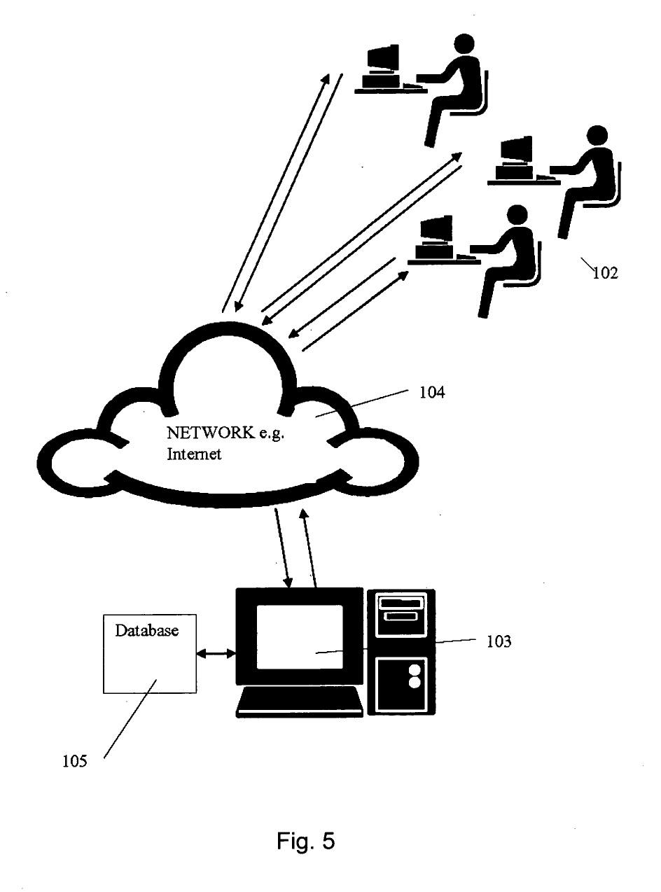

For example, as illustrated in FIG. 5, remote computers 102 may interact with the database 105. Using a network 104, such as the Internet, the computers 102 may access the server 103 with associated database 105. Accordingly, the server may process instructions, serve program codes for processing on remote computers 102, serve web pages with interfaces and store data in associated database 105, all for performing the methods described herein.

The present invention also contemplates a set of user interfaces that present user queries and accept inputs based on, for example, the schema of FIGS. 3A and 3B.

Persons skilled in the art will recognize that many modifications and variations are possible in the details, materials, and arrangements of the parts and actions which have been described and illustrated in order to explain the nature of this invention and that such modifications and variations do not depart from the spirit and scope of the teachings and claims contained therein.

What is claimed:

1. A method for business planning and performance, comprising:
(a) identifying a set of actual business projects for use in evaluating a set of business functions performed by a business entity, the functions being selected from the group comprising operations, finance, and marketing;
(b) evaluating the set of projects to determine a set of project parameters that influenced each business function for the projects;
(c) defining the desired objectives for each business function based on the project parameters;
(d) establishing benchmarks and/or performance measures for monitoring progress toward achieving the objectives for each business function;
(e) identifying and assigning roles with responsibilities for achieving specified benchmarks/performance measures.

2. The method of claim 1 comprising repeating one or more of steps (a) through (e) based on monitoring of performance for the business functions relative to the future projects as they become real projects.

3. The method of claim 1 wherein the business entity provides construction services.

4. The method of claim 1 wherein a project parameter relates to gross profit margin.

5. The method of claim 4 wherein project parameters relate to the business entity's communication skills or systems.

6. The method of claim 4 wherein a project parameter relates to the business entity's method for attracting a customer or obtaining work.

7. The method of claim 3 wherein the benchmarks are based on construction industry standards.

8. The method of claim 1 further comprising creating job descriptions for achieving objectives in operations, finance, or marketing.

9. A machine-readable medium storing a set of instructions for business planning and performance evaluation, comprising:
(a) identifying a set of actual business projects for use in evaluating a set of business functions performed by a business entity, the functions being selected from the group comprising operations, finance, and marketing;
(b) evaluating the set of projects to determine a set of project parameters that influenced each business function for the projects;
(c) defining the desired objectives for each business function based on the project parameters;
(d) establishing benchmarks and/or performance measures for monitoring progress toward achieving the objectives for each business function;
(e) identifying and assigning roles with responsibilities for achieving specified benchmarks/performance measures.

10. The machine-readable medium of claim 9 wherein the medium includes instructions repeating one or more of steps (a) through (e) based on monitoring of performance for the business functions relative to the future projects as they become real projects.

11. The machine-readable medium of claim 9 wherein the business entity provides construction services.

12. The machine-readable medium of claim 9 wherein a project parameter relates to gross profit margin.

13. The machine-readable medium of claim 12 wherein project parameters relate to the business entity's communication skills or systems.

14. The machine-readable medium of claim 12 wherein a project parameter relates to the business entity's method for attracting a customer or obtaining work.

15. The machine-readable medium of claim 11 wherein the benchmarks are based on construction industry standards.

16. The machine-readable medium of claim 9 further comprising creating job descriptions for achieving objectives in operations, finance, or marketing.
